(19) United States
(12) Patent Application Publication
(10) Pub. No.: US 2016/0280038 A1
(43) Pub. Date: Sep. 29, 2016

(54) VEHICLE SEAT AIR-CONDITIONING DEVICE

(71) Applicant: DENSO CORPORATION, Kariya-city, Aichi-pref. (JP)

(72) Inventors: Yuusuke TANAKA, Kariya-city (JP); Yasuhiko NIIMI, Kariya-city (JP); Takahisa FUJII, Kariya-city (JP)

(21) Appl. No.: 15/034,033

(22) PCT Filed: Oct. 16, 2014
(86) PCT No.: PCT/JP2014/005241

§ 371 Date: May 3, 2016

(30) Foreign Application Priority Data
Nov. 4, 2013 (JP) 2013-228878

(51) Int. Cl. B60H 1/00; B60N 2/56; B60H 1/24

(52) U.S. Cl. CPC B60H 1/00285; B60H 1/00564; B60H 1/244; B60H 1/00521; B60N 2/5628; B60N 2/5657

(57) ABSTRACT

A vehicle seat air-conditioning device has a branch duct and a blower. The branch duct is branched laterally from a ventilation duct on a condition of being mounted in a vehicle. The ventilation duct delivers air, which is blown from an air conditioning unit that air-conditions an inside of a vehicle compartment, to a periphery of a rear seat. The blower draws air from the branch duct and blows the air into a ventilation path formed in a blowing target seat. The blow is arranged on a lateral side of the ventilation duct on the condition of being mounted in the vehicle. Since the blower is arranged on the lateral side of the ventilation duct in the vehicle, the blower can be located at a lower position regardless of a length of the ventilation duct in an upper-lower direction. Therefore, a space in the vehicle that is occupied in the upper-lower direction by the ventilation duct and the blower as a whole can be reduced.

### CROSS REFERENCE TO RELATED APPLICATION

This application is based on Japanese Patent Application No. 2013-228878 filed on Nov. 4, 2013, the disclosure of which is incorporated herein by reference.

### TECHNICAL FIELD

The present disclosure relates to a vehicle seat air-conditioning device blowing conditioned air in a vehicle seat.

### BACKGROUND ART

Various vehicle seat air-conditioning devices that uses conditioned air of which temperature is adjusted by an air conditioning unit that air-conditions an inside of a vehicle compartment have been provided conventionally. For example, a vehicle seat air-conditioning device of Patent Literature 1 uses a rear-foot duct that delivers conditioned air from an air conditioning unit to a rear seat, and takes in the conditioned air from the rear-foot duct. According to Patent Literature 1, a cost can be reduced by omitting a dedicated duct.

The vehicle seat air-conditioning device of Patent Literature 1 further has a blower that blows the conditioned air taken in from the rear-foot duct to a front seat. The blower is arranged on an upper side of the rear-foot duct in an upper-lower direction of the vehicle.

### PRIOR ART LITERATURES

### Patent Literature

Patent Literature 1: JP H11-78484A

### SUMMARY OF INVENTION

Recently, an excess space is reduced to enlarge a vehicle compartment for a passenger's comfort, thereby a space under a seat that is conventionally left is getting smaller. Especially in an upper-lower direction of a vehicle, a space formed around a rear-foot duct under the seat is extremely small. As a result, with a structure of the vehicle seat air-conditioning device of Patent Literature 1 in which the blower is arranged on the upper side of the rear-foot duct, a space under the seat that has a height longer than a total length of a height of the blower and a height of the rear-foot duct is required. Accordingly, components of the vehicle seat air-conditioning device including blower are hardly disposed under the seat while securing enough blowing capacity of the blower. Thus, the vehicle seat air-conditioning device of Patent Literature 1 is hardly disposed in a space such as the space under the seat of which dimension in the upper-lower direction is strictly limited.

The present disclosure addresses the above issues, and it is an objective of the present disclosure to provide a vehicle seat air-conditioning device that can be easily disposed in a space of which dimension in an upper-lower direction of a vehicle is strictly limited.

A vehicle seat air-conditioning device of the present disclosure has a branch duct and a blower. The branch duct is branched laterally from a ventilation duct on a condition of being mounted in a vehicle. The ventilation duct delivers air, which is blown from an air conditioning unit that air-conditions an inside of a vehicle compartment, to a periphery of a rear seat. The blower draws air from the branch duct and blows the air into a ventilation path formed in a blowing target seat. The blower is arranged on a lateral side of the ventilation duct on the condition of being mounted in the vehicle.

According to the vehicle seat air-conditioning device, since the branch duct is branched laterally from the ventilation duct, and the blower is arranged on the lateral side of the ventilation duct in the vehicle on the condition of being mounted in the vehicle, the blower can be located at a lower position in the vehicle regardless of a length of the ventilation duct in the upper-lower direction. Therefore, a vehicle seat air-conditioning device that is easy to be disposed in a portion in a vehicle where a dimension in the upper-lower direction is strictly limited can be provided.

### BRIEF DESCRIPTION OF DRAWINGS

FIG. 1 is an exploded perspective view illustrating a vehicle seat air-conditioning device and a vehicle seat to which conditioned air is delivered from the vehicle seat air-conditioning device according to a first embodiment.

FIG. 2 is a partial detail view that enlarges a portion II shown in FIG. 1.

FIG. 3 is a sectional view taken along a line III-III shown in FIG. 2.

FIG. 4 is a perspective view illustrating a part of a vehicle seat air-conditioning device according to a second embodiment.

FIG. 5 is an exploded perspective view illustrating a part of a vehicle seat air-conditioning device on a condition that a vehicle seat is separated from a floor of a vehicle compartment, according to a third embodiment.

FIG. 6 is a side view illustrating the vehicle seat when viewed from a left side of a vehicle as shown by an arrow VI in FIG. 5.

FIG. 7 is a view illustrating an air outlet port of a rear-foot duct, a branch-duct connector portion, and a branch duct according to a fourth embodiment and a fifth embodiment.

FIG. 8 is a diagram illustrating a simulation result of airflow on a condition that a length of the branch-duct connector portion in a width direction of a vehicle is 200 mm, and that a length of the branch duct in a front-rear direction of the vehicle is 40 mm according to the fifth embodiment.

### DESCRIPTION OF EMBODIMENTS

Embodiments of the present disclosure will be described hereafter referring to drawings. In the embodiments, a part that corresponds to or equivalents to a matter described in a preceding embodiment may be assigned with the same reference number. A description of a part that corresponds to or equivalents to a matter described in a preceding embodiment may be omitted or simplified.

### First Embodiment

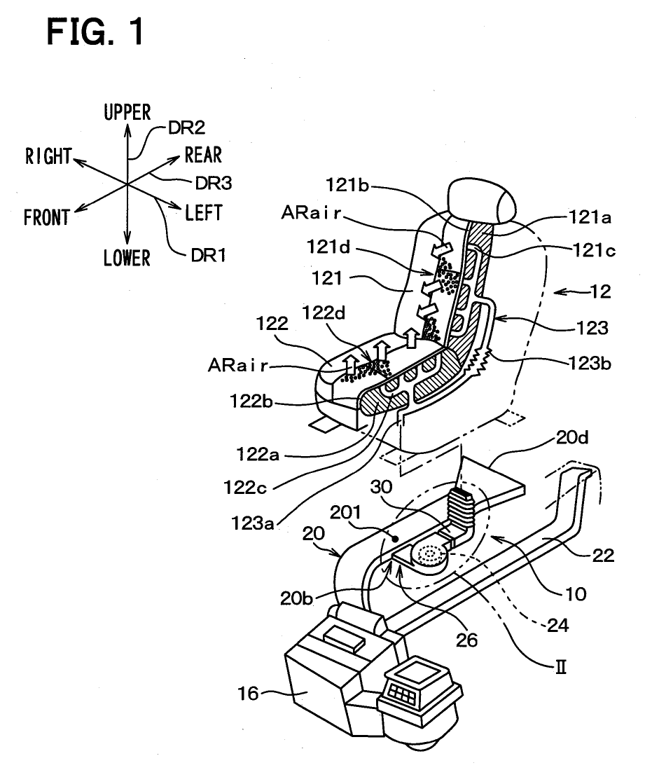

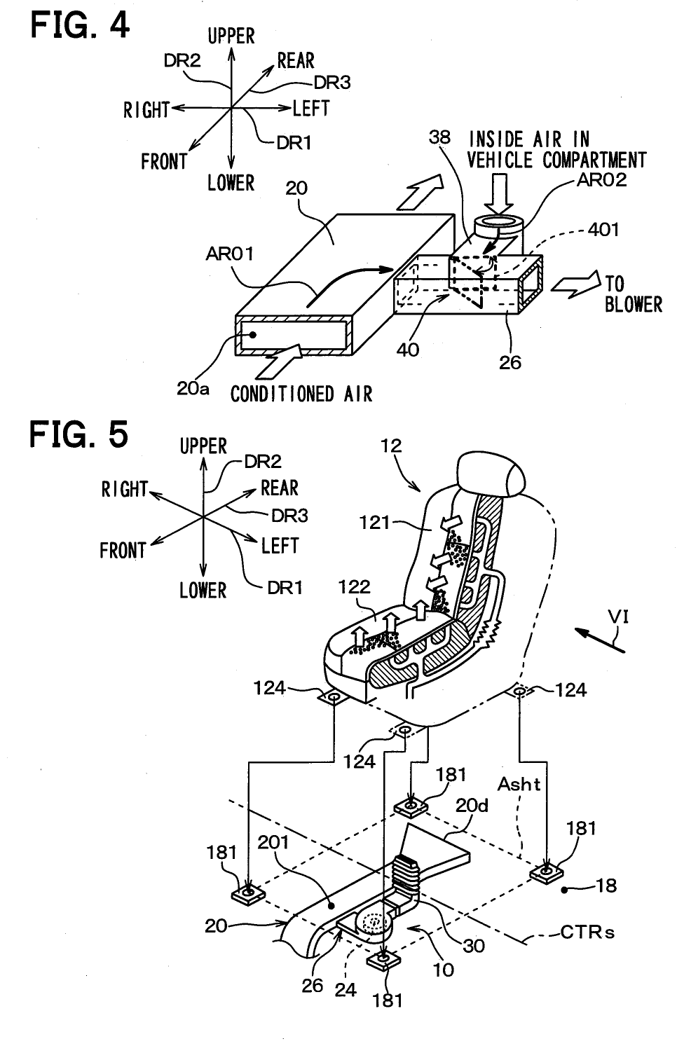

FIG. 1 is an exploded perspective view illustrating a vehicle seat air-conditioning device 10 and a vehicle seat 12 to which conditioned air is delivered from the vehicle seat air-conditioning device 10 according to a first embodiment. In FIG. 1, an arrow DR1 shows a left-right direction of a vehicle (i.e., a width direction of the vehicle), an arrow DR2 shows an upper-lower direction of the vehicle, and an arrow DR3 shows a front-rear direction of the vehicle. The left-right direction shown by the arrow DR1 is a direction on a basis of a front in a traveling direction of the vehicle, and an actual left-right direction shown in, for example, FIGS. 3, 4 may be reversed. In FIG. 1, a sectional view of the vehicle seat 12 is illustrated.

The vehicle seat 12 shown in FIG. 1 is a front seat that is arranged on a front side of a rear seat that is not shown. The vehicle seat 12 is a blowing target seat that is a target to which conditioned air is blown from the vehicle seat air-conditioning device 10 (that will be simply referred to as a seat air-conditioning device 10). The vehicle seat 12 has a back portion 121 that is a backrest and a seat cushion 122 that functions as a seat portion and supports a hip and thighs of a passenger (i.e., a seating person) who seats the vehicle seat 12. The vehicle seat 12 is symmetric laterally in the width direction DR1.

The seat cushion 122 of the vehicle seat 12 has a seat pad 122a that is made of urethane foam having elasticity and a seat surface 122b that covers a surface of the seat pad 122a on a side adjacent to the passenger.

The seat pad 122a is provided with a seat ventilation path (i.e., a ventilation path) 122c that is branched such that conditioned air delivered from the seat air-conditioning device 10 can be delivered to an entirety of the seat surface 122b. The seat surface 122b has a perforation configured by a material such as natural leather or artificial leather. The seat surface 122b is provided with microscopic pores 122d that pass through the seat surface 122b in a thickness direction.

The conditioned air blown to the seat surface 122b from the seat ventilation path 122c is blown to a side of the seat cushion 122 adjacent to the passenger through the microscopic pores 122d as shown by an arrow ARair. A structure of the back portion 121 is similar to a structure of the seat cushion 122. In FIG. 1, a seat pad of the back portion 121 is shown with a numeral 121a, a seat surface of the back portion 121 is shown with a numeral 121b, a seat ventilation path (i.e., a ventilation path) of the back portion 121 is shown with a numeral 121c, and microscopic pores of the back portion 121 are shown with a numeral 121d.

The vehicle seat 12 has a distribution duct 123 that distributes the conditioned air from the seat air-conditioning device 10 to the ventilation path 121c of the back portion 121 and the ventilation path 122c of the seat cushion 122. The distribution duct 123 has an air introduction port 123a that is an inlet for the conditioned air from the seat air-conditioning device 10. The distribution duct 123 is connected to both of the ventilation paths 121c, 122c and introduces the air introduced to the air introduction port 123a to each of the ventilation paths 121c, 122c.

The distribution duct 123 has a flexible portion 123b that deforms to accept the back portion 121 to be reclined. For example, the flexible portion 123b has flexibility by having a bellows shape.

As shown in FIG. 1, the seat air-conditioning device 10 is disposed under the vehicle seat 12. The seat air-conditioning device 10 draws conditioned air from an air conditioning unit 16 that air-conditions an inside of a vehicle compartment, and delivers the conditioned air to the vehicle seat 12. The conditioned air is blown toward the passenger from the microscopic pores 121d, 122d of the back portion 121 and the seat cushion 122. The seat air-conditioning device 10 is able to blow cool air that is cooled in the air conditioning unit 16 from the vehicle seat 12 in a cooling, and is able to blow warm air that is heated in the air conditioning unit 16 from the vehicle seat 12 in a heating.

The air conditioning unit 16 is a general air conditioning unit that has an evaporator and a heater core and is disposed in an instrument panel located on a front side of the vehicle compartment. The air conditioning unit 16 performs an air-conditioning for the inside of the vehicle compartment by refrigerant that is heated or cooled by a heat exchanger located outside of the vehicle compartment and circulates in the air conditioning unit 16. A rear-foot duct 20 and a rear-vent duct 22 are disposed on a floor 18 of the vehicle compartment (refer FIG. 3). The rear-foot duct 20 and the rear-vent duct 22 are respectively connected to different air outlet ports of the air conditioning unit 16.

Each of the rear-foot duct 20 and the rear-vent duct 22 is a piping member that delivers the conditioned air blown from the air conditioning unit 16 to a periphery of the rear seat. Specifically, the rear-foot duct 20 has an air outlet port 20d that is open to blow air to the periphery of the rear seat and delivers cool air or warm air of which temperature is adjusted by the air conditioning unit 16 to a foot area of a rear passenger having the rear seat. The rear-vent duct 22 delivers the cool air that is cooled by the air conditioning unit 16 to the rear passenger. The rear-foot duct 20 corresponds to a ventilation duct of the present disclosure.

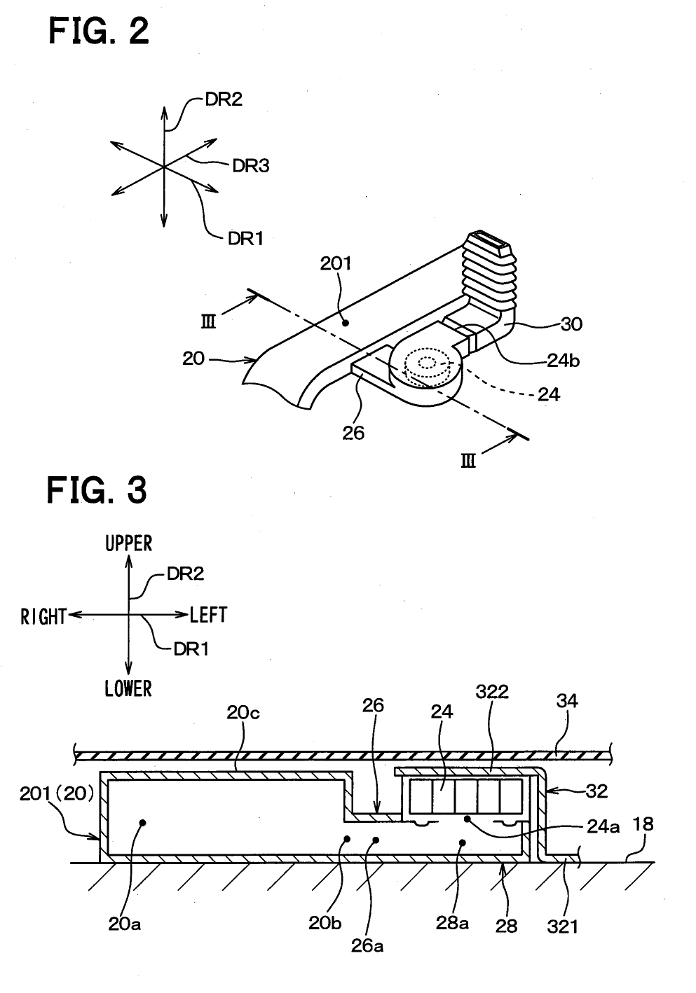

FIG. 2 is a partial detail view that enlarges a portion II shown in FIG. 1. FIG. 3 is a sectional view taken along a line III-III shown in FIG. 2. As shown in FIGS. 2 and 3, the seat air-conditioning device 10 has a blower 24, a branch duct 26, an air inlet part 28, a connection duct 30, and a blower bracket 32 (referred to as a bracket 32 hereafter).

The blower 24 is an electric centrifugal blower that draws air from an air suction port 24a and blows the air from the air outlet port 24b. The blower 24 is arranged on a lateral side (i.e., a right side in FIG. 3) of the rear-foot duct 20 in the vehicle. That is, the blower 24 is arranged at a position that is misaligned with respect to the rear-foot duct 20 in a horizontal direction.

The blower 24 is arranged such that the air suction port 24a is open downward, and that the air outlet port 24b is open backward in the front-rear direction DR3. That is, the blower 24 draws air from a lower side and blows to a lateral side. The blower 24 rotates based on a control signal from a controller that is not shown and blows air. The vehicle seat air-conditioning unit 10 has the controller.

The branch duct 26 is a piping member that is branched from a branch section 20b to the lateral side of the rear-foot duct 20. The branch section 20b is open in a part of a side wall of the rear-foot duct 20 that forms an air passage 20a having a rectangular shape in cross section. That is, the branch duct 26 is the piping member that is branched from the branch section 20b in the horizontal direction of the vehicle.

Specifically, the rear-foot duct 20 has a branch-duct connector portion 201 that includes the branch section 20b and is connected with the branch duct 26. The branch duct 26 branches from the branch-duct connector portion 201 leftward in the width direction DR1 and forms an air path 26a that has a rectangular shape in cross section. the branch duct 26 extends from the branch section 20b in the width direction DR1 and has one end that communicates with the air passage 20a formed in the rear-foot duct 20 and an other end that communicates with an air inlet space 28a formed in the air inlet part 28. A height from the floor 18 to the branch duct 26 is lower than or equal to a height from the floor 18 to the rear-foot duct 20.

The air inlet part 28 is arranged below the blower 24 in the upper-lower direction DR2. The air inlet part 28 forms the air inlet space 28a that is open to the air suction port 24a of the blower 24. Accordingly, the conditioned air flowing in the rear-foot duct 20 is drawn by the blower 24 after passing through the branch duct 26 and the air inlet part 28 in sequence. The air inlet part 28, the branch duct 26, and the rear-foot duct 20 are made of resin and formed integrally with each other by a method such as an injection molding.

As shown in FIG. 3, in cross section at a portion in which the rear foot duct 20 branches to the branch duct 26, an uppermost portion of the rear-foot duct 20 in the upper-lower direction DR2, in other words, an uppermost portion of the branch-duct connector portion 201 is a duct upper surface (i.e., an upper surface) 20c. The air inlet part 28 is formed such that the air suction port 24a of the blower 24 is located below the upper surface 20c in the upper-lower direction DR2.

The connection duct 30 shown in FIG. 2 is a member that is made of resin formed by injection molding or vacuum molding and is a piping member that guides the conditioned air, which is blown from the air outlet port 24b of the blower 24, to an air introduction port 123a (refer FIG. 1) of the distribution duct 123. That is, the connection duct 30 has one end that connects to the air outlet port 24b of the blower 24 and an other end that connects to the air introduction port 123a of the distribution duct 123. Accordingly, the air outlet port 24b of the blower 24 connects to the ventilation paths 121c, 122c through the connection duct 30 and the distribution duct 123 (refer FIG. 1). As a result, the blower 24 can draw air from the branch duct 26 and blow into the ventilation paths 121c, 122c that are formed in the vehicle seat 12.

The connection duct 30 has a shape that is bent to be L-shape such that the air outlet port 24b of the blower 24 opening leftward communicates with the air introduction port 123a opening downward (refer FIG. 1). The connection duct 30 has a portion having a bellows shape to have flexibility such that the back portion 121, the seat cushion 122, and the distribution duct 123 become movable in the front-rear direction DR3.

The bracket 32 shown in FIG. 3 is a metal member that is formed by a method such as press molding. The bracket 32 is a supporting member that supports the blower 24, which is arranged on the lateral side of the rear-foot duct 20, with respect to the floor 18 of the vehicle compartment in the vehicle. The bracket 32 has a crank shape. The bracket 32 has a fixing portion 321 that is fixed to the floor 18, which configures a part of the vehicle, by a method such as bolting and a blower supporting portion 322 to which the blower 24 is attached to be supported thereby. For example, the blower 24 may be fixed to the blower supporting portion 322 by bolting. Alternatively, the blower 24 may be fixed to the blower supporting portion 322 through a shock-absorbing material or the like such as a spring or urethane foam resin to suppress a transmission of vibration from the blower 24 to the floor 18.

The blower supporting portion 322 of the bracket 32 is arranged an upper side of the blower 24. The blower 24 is supported with respect to the blower supporting portion 322 of the bracket 32 on the upper side of the blower 24, thereby fixed with respect to the floor 18 of the vehicle compartment.

As shown in FIG. 3, a carpet 34 as a rug is placed on the floor 18 of the vehicle compartment. Accordingly, an upper side of the carpet 34 is an interior space of the vehicle compartment, and the passenger steps an upper surface of the carpet 34. The carpet 34 is similar to a general carpet that is placed in a vehicle compartment in a vehicle. The blower 24 is interposed between the floor 18 and the carpet 34 under the vehicle seat 12 together with the rear-foot duct 20. That is, the carpet 34 is placed above the rear-foot duct 20 and the bracket 32. The bracket 32 is formed such that a height of the blower supporting portion 322 is the same height as a height of the rear-foot duct 20 to prevent the upper surface of the carpet 34 from being rough. The same height is defined as a height from a mutual base level, however is not required to be strictly the same value and includes an error in a range in which the upper surface of the carpet 34 is prevented from being especially rough.

As described above, according to the present embodiment, the branch duct 26 branches laterally from the rear-foot duct 20, and the blower 24 is arranged on the lateral side of the rear-foot duct 20, on a condition of being mounted in the vehicle that is a condition where the seat air-conditioning device 10 is mounted in the vehicle. Therefore, the blower 24 can be located at a lower position regardless of the length of the rear-foot duct 20 in the upper-lower direction DR2. As a result, the blower 24 can be easily disposed under the vehicle seat 12 where a dimension in the upper-lower direction DR2 is strictly limited. Therefore, a space in the vehicle that is occupied in the upper-lower direction DR2 by the rear-foot duct 20 and the blower 24 as a whole can be reduced.

Furthermore, a length of the blower 24 in the upper-lower direction DR2 is not limited by the length of the rear-foot duct 20 in the upper-lower direction DR2. Accordingly, a size of the blower 24 in the upper-lower direction DR2 is less limited by the rear-foot duct 20. Therefore, a blowing capacity of the blower 24 can be secured regardless of the length of the rear-foot duct 20 in the upper-lower direction DR2.

Moreover, the blower 24 of the present embodiment can be mounted at a position near the floor 18 of the vehicle compartment, that is, the blower 24 can be mounted at a position away from ears of the passenger, as compared to a conventional structure in which a blower is located above a rear-foot duct as disclosed in Patent Literature 1. Since the upper side of the blower 24 is covered with the carpet 34, a sound insulation effect of the carpet 34 can be obtained. Therefore, a noise reaching the passenger can be kept at a lower level.

According to the present embodiment, since the blower 24 is supported with respect to the floor 18 of the vehicle compartment and is not supported with respect to the vehicle seat 12, a vibration of the blower 24 is hard to transmit to the vehicle seat 12. As a result, the vibration of the blower 24 is hard to transmit to the passenger having the vehicle seat 12.

According to the present embodiment, as shown in FIG. 3, the rear-foot duct 20, the blower 24, and the bracket 32 are interposed between the floor 18 of the vehicle compartment and the carpet 34 under the vehicle seat 12. Therefore, an enough space under the vehicle seat 12 in which toes of the rear passenger are inserted can be secured easily.

According to the conventional structure in which the blower is arranged above the rear-foot duct as disclosed in Patent Literature 1, the air suction port of the blower is located just adjacent to the air passage in the rear-foot duct. In contrast, according to the present embodiment, a certain distance from the air passage 20a in the rear-foot duct 20 to the air suction port 24a of the blower 24 can be secured. Therefore, a velocity distribution of air inside the air passage 20a defined in the rear-foot duct 20 can be easily prevented from being disturbed due to a fan rotation of the blower 24 as compared to the conventional structure that is described above. Thus, when the conditioned air is blown from the rear-foot duct 20 to a foot area of the rear passenger, an uncomfortable feeling that the rear passenger may feel due to the disturbance of the velocity distribution of air can be reduced.

According to the present embodiment, the air outlet port 24b of the blower 24 is connected with the ventilation paths 121c, 122c through the connection duct 30 having flexibility. Accordingly, the branch duct 123 delivers the conditioned air blown from the blower 24 that is an on-floor disposed type to the vehicle seat 12 while being accepting the back portion 121 and the seat cushion 122 to move in the front-rear direction DR3.

According to the present embodiment, the inlet part 28 that forms the air inlet space 28a opening to the air suction port 24a of the blower 24 is arranged below the blower 24. Accordingly, the blower 24 draws air from the lower side and blows the air laterally, and the air is delivered to the ventilation paths 121c, 122c of the vehicle seat 12 that is located above the blower 24. Here, in a case where the air inlet part 28 is arranged above the blower 24, the blower 24 draws air from the upper side, and the air is delivered to the ventilation paths 121c, 122c that are located above the blower 24. That is, the air blown by the blower 24 U-turns. In contrast, according to the structure of the present embodiment, the air blown by the blower 24 can be delivered to the vehicle seat 12 smoothly without being U-turned.

According to the present embodiment, as shown in FIG. 3, in cross section at the portion in which the rear foot duct 20 branches to the branch duct 26, the air inlet part 28 is formed such that the air suction port 24a of the blower 24 is located on the lower side in the upper-lower direction DR2 with respect to the upper surface 20c that is the upper most portion of the rear-foot duct 20 in the upper-lower direction DR2. Therefore, in the space under the vehicle seat 12 of which dimension in the upper-lower direction DR2 is strictly limited, a height of a part of the blower 24 that protrudes from the upper surface 20c of the rear-foot duct 20 in the upper-lower direction DR2 can be small. Alternatively, the blower 24 can be prevented from protruding from the upper surface 20c in the upper-lower direction DR2.

### Second Embodiment

A second embodiment of the present disclosure will be described. In the present embodiment, features that are different from the first embodiment will be described mainly.

The seat air-conditioning device 10 of the present embodiment is different from that of the first embodiment and can deliver air inside of the vehicle compartment, not only the conditioned air from the air conditioning unit 16, to the vehicle seat 12 without passing through the air conditioning unit 16. FIG. 4 is a perspective view illustrating a part of the seat air-conditioning device 10 of the present embodiment.

As shown in FIG. 4, the seat air-conditioning device 10 has a communication duct 38 and an introducing air switching mechanism 40 on a suction side of the blower 24. The communication duct 38 is a duct protrudes laterally from the branch duct 26, specifically to a rear side of the vehicle. The communication duct 38 is made of, for example, resin, and formed integrally with the branch duct 26.

Specifically, the communication duct 38 has one end that connects to and communicates with the air path 26a and an other end that is open upward toward the inside of the vehicle compartment. Since the communication duct 38 is open to the inside of the vehicle compartment, the communication duct 38 functions as an inside-air introducing portion into which air inside of the vehicle compartment flows. The carpet 34 is placed on the communication duct 38 and the branch duct 26. Accordingly, the carpet 34 is provided with an un-shown through hole to open the other end of the communication duct 38 to the inside of the vehicle compartment defined above the carpet 34.

The introducing air switching mechanism 40 has a rotational door 401 that is disposed in the branch duct 26 and an actuator that operates the rotational door 401 to rotate based on a control signal from a controller that is not shown. The introducing air switching mechanism 40 corresponds to a switching mechanism of the present disclosure. The introducing air switching mechanism 40 alternatively flows air delivered from the rear-foot duct 20 or air delivered from the communication duct 38 to the air suction port 24a (refer FIG. 3) of the blower 24.

Specifically, the introducing air switching mechanism 40 opens a first ventilation path in which air flows from the branch section 20b to the air suction port 24a of the blower 24, on the other hand closes a second ventilation path in which air flows from the communication duct 38 to the air suction port 24a. Accordingly, air delivered from the rear-foot duct 20 flows to the air suction port 24a as shown by an arrow AR01. A position of the rotational door 401 at this time is shown by a dashed line in FIG. 4.

In contrast, when the introducing air switching mechanism 40 closes the first ventilation path and opens the second ventilation path by the rotational door 401, air delivered from the communication duct 38 flows to the air suction port 24a of the blower 24 as shown by an arrow AR02. A position of the rotational door 401 at this time is shown by a two-dot line in FIG. 4.

According to the present embodiment, since the blower 24 is arranged similar to the first embodiment, the same effect as the first embodiment can be obtained.

Further, according to the present embodiment, the conditioned air from the air conditioning unit 16 or the air inside of the vehicle compartment can be delivered to the vehicle seat 12 as required. Therefore, in a case where, for example, the cool air from the air conditioning unit 16 is too cool in the cooling, a seat surface of the vehicle seat 12 can be prevented from being cooled too much, by ventilating a cooled air inside of the vehicle compartment to the vehicle seat 12, for example, based on an operation by the passenger. Thus, a temperature control of air that is blown from the vehicle seat 12 can be performed easily according to an inside environment of the vehicle compartment or a passenger's preference.

Moreover, according to the present embodiment, since the communication duct 38 is a duct that protrudes laterally from the branch duct 26, a length of the communication duct 38 in the upper-lower direction DR2 can be prevented from increasing.

### Third Embodiment

A third embodiment of the present disclosure will be described. In the present embodiment, features that are different from the first embodiment will be described mainly.

As shown in FIG. 5, the vehicle seat 12 has a seat connector 124 at each of four corners of the vehicle seat 12 on a lower side of the vehicle seat 12 to connect the vehicle seat 12 to the floor 18 of the vehicle compartment. That is, the vehicle seat 12 has four seat connectors 124. The seat connectors 124 are configured by a metal plate molded by a method such as pressing and are respectively fastened to four seat fixing parts 181 that are disposed on the floor 18 of the vehicle compartment.

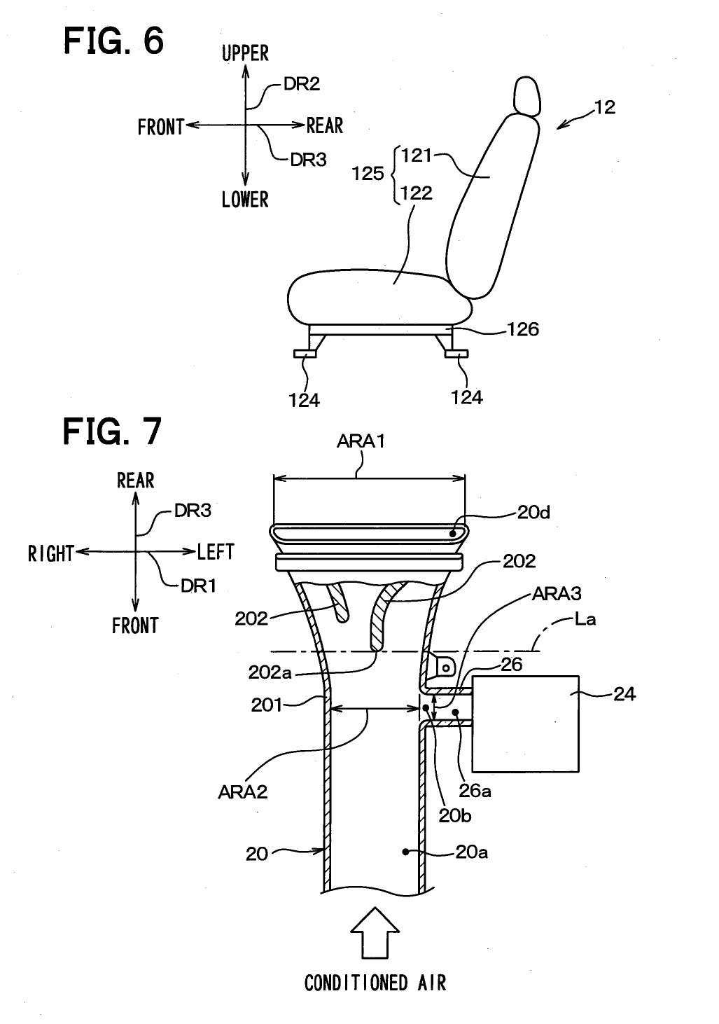

FIG. 6 is a side view illustrating the vehicle seat 12 when viewed from a left side of the vehicle as shown by an arrow VI in FIG. 5. As shown in FIG. 6, the vehicle seat 12 has a seat rail 126 that enables a seat body 125 including the back portion 121 and the seat cushion 122 to move in the front-rear direction DR3. The four seat connectors 124 are connected to the seat cushion 122 through the seat rail 126. Therefore, the passenger can move the seat body 125 in the front-rear direction DR3.

As shown in FIG. 5, at a relative position of the vehicle seat 12 and the seat air-conditioning device 10 in the front-rear direction DR3, the blower 24 of the seat air-conditioning device 10, the branch duct 26, and the connection duct 30 are arranged in a front portion of a seat occupation area (i.e., an area) Asht that is defined as an inside of a quadrangle of which four corners respectively coincide with the four seat connectors 124 of the vehicle seat 12. Specifically, the blower 24, the branch duct 26, and the connection duct 30 are arranged in the area Asht on a front side of a center CTRs of the area Asht in the front-rear direction DR3.

According to the present embodiment, since the blower 24 is arranged similar to the first embodiment, the same effect as the first embodiment can be obtained.

Furthermore, according to the present embodiment, the blower 24 that may become a noise generation source is arranged in a front area in the area Ast under the vehicle seat 12. Accordingly, the seat cushion 122 as the sound absorption member is located between the blower 24 and a position corresponding to ears of the passenger. A shortest path through which a sound generated by the blower 24 reaches to the ears of the passenger is a path from a rear side of the seat cushion 122 to the position corresponding to ears. According to the present embodiment, a distance from the blower 24 to the rear side of the seat cushion 122 can be secured to be long. By an attenuation effect of the sound based on the distance, noise that the passenger feels can be decrease.

Here, in a case where the branch duct 26 is connected to a part adjacent to the air outlet port 20d of the rear-foot duct 20, even when an enough amount of the conditioned air is supplied from the air conditioning unit 16, the blower 24 easily draws air from the air outlet port 20d of the rear-foot duct 20, and air counterflows easily in the rear-foot duct 20 from the air outlet port 20d to the branch section 20b. Moreover, the conditioned air from the air conditioning unit 16 easily flows out of the air outlet port 20d without being drawn into the branch duct 26. When the conditioned air from the air conditioning unit 16 leaks from the air outlet port 20d, cool air from the air conditioning unit 16 blows toward the foot area of the rear passenger on a condition where the seat air-conditioning device 10 operates the cooling operation, and a comfort of the rear passenger may deteriorate.

According to the present embodiment, the branch duct 26 is arranged in the front area of the area Asht, thereby the branch duct 26 connects to the rear-foot duct 20 at a position away from the air outlet port 20d of the rear-foot duct 20 on an upstream side in an airflow direction. Therefore, the conditioned air can be prevented from counterflowing in the rear-foot duct 20 and leaking from the air outlet port 20d, for example, without an opening/closing mechanism to open or close the air outlet port 20d.

According to the present embodiment, since the branch duct 26 is arranged in the front area of the area Asht, an air passage from the air conditioning unit 16 to the vehicle seat 12 can be shortened. For example, in a case of cooling the vehicle compartment rapidly when a temperature inside of the vehicle compartment is high, cool air from the air conditioning unit 16 is easily heated in the rear-foot duct 20. However, a comfortable cool air can be supplied to the vehicle seat 12 by shortening a length of the rear-foot duct 20 in the airflow direction.

According to the present embodiment, the blower 24, the branch duct 26, and the connection duct 30 are arranged in the front area in the area Asht. Therefore, as compared with a case where those components are arranged on a rear area in the area Asht, toes of the rear passenger can be inserted in the space under the vehicle seat 12 easily.

The present embodiment can be combined with the above-described second embodiment.

### Fourth Embodiment

A fourth embodiment of the present disclosure will be described. In the present embodiment, features that are different from the first embodiment will be described mainly.

A seat air-conditioning device 10 of the present embodiment is different from that of the first embodiment in a point where a position in which the branch duct 26 is connected to the rear-foot duct 20, in other words, a position of the branch-duct connector portion 201 is limited. The feature is shown in FIG. 7. FIG. 7 is a view illustrating the air outlet port 20d of the rear-foot duct 20, the branch-duct connector portion 201, and the branch duct 26. A cross section of the branch-duct connector portion 201 and the branch duct 26 is illustrated in FIG. 7.

As shown in FIG. 7, a width of the rear-foot duct 20 increases toward the air outlet port 20d on a downstream side of the branch-duct connector portion 201 in the airflow direction. That is, the branch-duct connector portion 201 is a narrow portion that is formed such that a sectional area ARA2 of the branch-duct connector portion 201 is smaller than an opening area ARA1 of the air outlet port 20d. In FIG. 7, for example, an opening width of the air outlet port 20d in the width direction DR1 is 240 mm, a length of the air passage 20a in the branch-duct connector portion 201 in the width direction DR1 is 130 mm, and a length of the air path 26a in the branch duct 26 in the front-rear direction DR3 is 40 mm. When it is said a sectional area of a duct as mentioned above, it means is a sectional area of a passage in the duct measured along a line perpendicular to an airflow direction in the duct.

A wind direction guide 202 that sets a flow direction of air in the air outlet port 20d is formed in the rear-foot duct 20. In FIG. 7, two wind direction guides 202 are provided. The branch duct 26 is connected to the rear-foot duct 20 at a position outside of the wind direction guide 202 in the flow direction of air in the rear-foot duct 20. Specifically, the branch duct 26 is connected to the rear-foot duct 20 on an upstream side of an upstream end 202a of the wind direction guide 202, which is located on an upstream end in the wind direction guide 202, in the airflow direction. In FIG. 7, a position of the upstream end 202a of the wind direction guide 202 in the airflow direction in the rear-foot duct 20 is shown by a straight line La.

According to the present embodiment, since the blower 24 is arranged similar to the first embodiment, the same effect as the first embodiment can be obtained.

According to the present embodiment, the branch duct 26 is connected to the rear-foot duct 20 on an upstream side of an upstream end 202a of the wind direction guide 202, which is located on an upstream end in the wind direction guide 202, in the airflow direction. As a result, airflow in the rear-foot duct 20 is branched to the branch duct 26, and the rest of air flows along the wind direction guide 202. Therefore, when air is blown from the air outlet port 20d of the rear-foot duct 20, a deterioration of the velocity distribution of air flowing along the wind direction guide 202 can be suppressed, and an uncomfortable feeling that the rear passenger may feel when the air from the air outlet port 20d reaches to the rear passenger can be suppressed.

The branch duct 26 is connected to the rear-foot duct 20 at a position outside of the wind direction guide 202 in the flow direction of air in the rear-foot duct 20. That is, in the rear-foot duct 20, the wind direction guide 202 does not extend to the branch-duct connector portion 201. Therefore, a counterflow of air by drawing air from the air outlet port 20d of the blower 24 can be prevented from causing due to the wind direction guide 202. Therefore, for example, the opening/closing mechanism to open or close the air outlet port 20d for restricting the counterflow of air is unnecessary.

According to the present embodiment, a width of the rear-foot duct 20 increases toward the air outlet port 20d on a downstream side of the branch-duct connector portion 201 in the airflow direction. That is, the branch duct 26 is connected to the rear-foot duct 20 in a portion where the length of the rear-foot duct 20 in the width direction DR1 is short. Therefore, a space in the width direction under the vehicle seat 12 that is occupied by the seat air-conditioning device 10 and the rear-foot duct 20 as a whole can be smaller. Accordingly, for example, the seat air-conditioning device 10 and the rear-foot duct 20 can be easily mounted in the vehicle.

The present embodiment can be combined with the second embodiment or the third embodiment.

### Fifth Embodiment

A fifth embodiment of the present disclosure will be described. In the present embodiment, features that are different from the fourth embodiment will be described mainly.

A seat air-conditioning device 10 of the present embodiment is different from that of the fourth embodiment in a point where a relation among the opening area ARA1 of the air outlet port 20d, the sectional area ARA2 of the branch-duct connector portion 201, and the sectional area ARA3 of the branch duct 26 is specified.

Specifically, the sectional area ARA3 of the branch duct 26 shown in FIG. 7 is larger than or equal to 20% of the sectional area ARA2 of the branch-duct connector portion 201 (a first condition). The sectional area ARA2 of the branch-duct connector portion 201 is smaller than or equal to 80% of the opening area ARA1 of the air outlet port 20d (a second condition). The sectional area ARA2 of the branch-duct connector portion 201 is, specifically the sectional area ARA2 of the air passage 20a of the branch-duct connector portion 201.

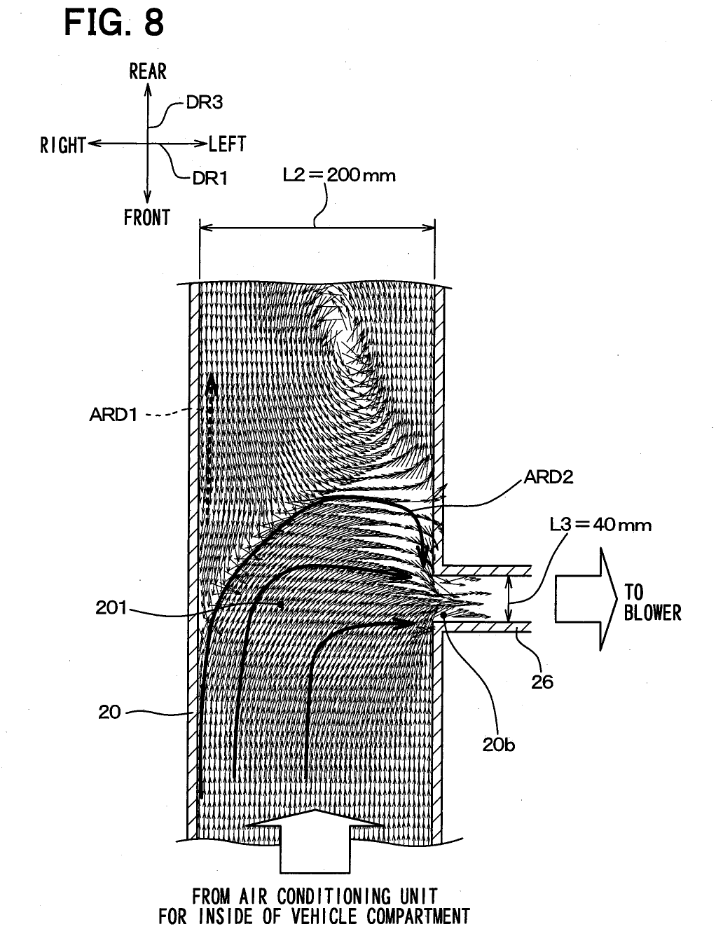

For example, airflow in the rear-foot duct 20 on a condition of satisfying the first condition is shown in FIG. 8. FIG. 8 is a diagram illustrating a simulation result of the airflow on a condition that a length L2 of the branch-duct connector portion 201 in the width direction DR1 is set to 200 mm, and that a length L3 of the branch duct 26 in the front-rear direction DR3 is set to 40 mm. In the simulation of the airflow, it is assumed that a length of the branch duct 26 in the upper-lower direction DR2 is equal to a length of the branch-duct connector portion 201 in the upper-lower direction DR2. Therefore, in FIG. 8, the sectional area ARA3 of the branch duct 26 is 20% of the sectional area ARA2 of the branch-duct connector portion 201. Further, it is assumed that a volume of air drawn by the blower 24 from the rear-foot duct 20 is equal to a volume of air supplied to the rear-foot duct 20.

As shown in the simulation result in FIG. 8, by satisfying the first condition, air flowing in the rear-foot duct 20 from an upstream side of the branch-duct connector portion 201 is drawn into the branch duct 26 along a whole length of the branch-duct connector portion 201 in the width direction DR1. That is, the air flows as shown by a thick solid arrow in FIG. 8.

Specifically, in a case where the sectional area ARA3 of the branch duct 26 is extremely smaller than the sectional area ARA2 of the branch-duct connector portion 201, air flowing on a side opposite to the branch duct 26 in the rear-foot duct 20 easily flows straight as shown by a dashed arrow ARD1. However, according to the simulation result in FIG. 8, the air flows to the branch duct 26 as shown by a solid arrow ARD2.

That is, the above-described conditions are set such that the air flowing on the opposite side of the branch duct 26 in the rear-foot duct 20 flows into the branch duct 26 in a case where the volume of air drawn by the blower 24 from the rear-foot duct 20 is equal to the volume of air supplied to the rear-foot duct 20 from the air conditioning unit 16. Accordingly, by satisfying the first condition, the air can be prevented from counterflowing and leaking in the rear-foot duct 20 without, for example, the opening/closing mechanism to open or close the air outlet port 20d.

According to the present embodiment, since the rear-foot duct 20 and the branch duct 26 have similar structures as the fourth embodiment, the same effect as the fourth embodiment can be obtained.

According to the first condition of the present embodiment, the sectional area ARA3 of the branch duct 26 is larger than or equal to 20% of the sectional area ARA2 of the branch-duct connector portion 201. Therefore, as compared with a case where the first condition is not satisfied, a certain volume of U-turning flow of air that U-turns and is drawn into the branch duct 26 after passing through the branch-duct connector portion 201 in the rear-foot duct 20 can be suppressed. By suppressing the U-turning flow of the air in the rear-foot duct 20, a pressure loss on the air suction side of the blower 24 can be decreased.

According to the second condition, the sectional area ARA2 of the branch-duct connector portion 201 is smaller than or equal to 80% of the opening area ARA1 of the air outlet port 20d. Therefore, the conditioned air is certainly blown to the foot area of the rear passenger over a wide range from the air outlet port 20d of which width is wide, and a suction force of the blower 24 easily reaches to the opposite side of the branch duct 26 in the branch-duct connector portion 201. As a result, a leaking of the air in the rear-foot duct 20 can be suppressed.

(Other Modification)

(1) Regarding the second embodiment, although the communication duct 38 functions as the inside-air introducing portion into which inside air of the vehicle compartment flows, the inside-air introducing portion is not necessary to be a duct. For example, the inside-air introducing portion may be a simple opening hole that is provided with the branch duct 26 to be open to the inside of the vehicle compartment.

(2) Although the wind direction guide 202 is provided inside of the rear-foot duct 20 according to the fourth and fifth embodiments, the wind direction guide 202 is not a necessary structure and may be omitted.

(3) Although both the first condition in which the sectional area ARA3 of the branch duct 26 is larger than or equal to 20% of the sectional area ARA2 of the branch-duct connector portion 201 and the second condition in which the sectional area ARA2 of the branch-duct connector portion 201 is smaller than or equal to 80% of the opening area ARA1 of the air outlet port 20d are satisfied according to the fifth embodiment, only one of the first condition and the second condition may be satisfied.

(4) According to the above-described embodiments, the seat air-conditioning device 10 blows the cool air, which is cooled in the air conditioning unit 16, from the vehicle seat 12 in the cooling, and blows the warm air, which is heated in the air conditioning unit 16, from the vehicle seat 12 in the heating. However, it is unnecessary to have a function blowing the cool air or the warm air alternatively, and the seat air-conditioning device 10 may blow only one of the cool air or the warm air from the vehicle seat 12.

(5) Although the branch duct 26 of the seat air-conditioning device 10 is connected to the rear-foot duct 20 according to the above-described embodiments, the branch duct 26 may be connected to any other duct as long as the conditioned air that is air-conditioned in the air conditioning unit 16 flows in the duct.

(6) According to the above-described embodiments, the seat air-conditioning device 10 blows the conditioned air, which is drawn from the rear-foot duct 20, from the vehicle seat 12 without heating or cooling. However, a heater that heats the conditioned air or a cooler that cools the conditioned air may be disposed.

(7) Although the air inlet part 28 is arranged on the lower side of the blower 24 in the upper-lower direction DR3, and the blower 24 draws air from the lower side of the blower 24, according to the above-described embodiments, the blower 24 may draw air from any direction. For example, the air inlet part 28 may be arranged on an upper side of the blower 24 in the upper-lower direction DR3, and the blower 24 may draw air from the upper side.

(8) Although the blower 24 is a centrifugal blower according to the above-described embodiments, of which type is not limited and may be an axial blower.

(9) Although the seat surfaces 121b, 122b are made of a material such as natural leather or artificial leather according to the above-described embodiments, the material may be a woven fabric such as moquette. In such a case, voids defined in a texture of the woven fabric may function as the microscopic pores 121d, 122d.

(10) According to the above-described embodiments, the ventilation paths 121c, 122c into which the conditioned air blown by the blower 24 flows are formed in the seat pads 121a, 122a. However, the ventilation paths 121c, 122c may be formed separately from the seat pads 121a, 122a.

The present disclosure is not limited to the above-described embodiments and can be modified within the scope of the present disclosure as defined by the appended claims. The above-described embodiments are not unrelated to each other and can be combined with each other except for a case where the combination is clearly improper. In the above-described embodiments, it is to be understood that elements constituting the embodiments are not necessary except for a case of being explicitly specified to be necessary and a case of being considered to be absolutely necessary in principle. Even when a factor such as a quantity of elements, a value, an amount, a range is mentioned in the above-described embodiments, it is to be understood that the factor is not limited to a specific value except for a case of being explicitly specified to be necessary and a case of being considered to be absolutely necessary in principle. Even when a feature such as a material forming a member, a shape of a member, a positional relation of members, it is to be understood that such feature is not limited to a specific material, shape, positional relation, or the like except for a case of being explicitly specified to be necessary and a case of being considered to be absolutely necessary in principle.

What is claimed is:

1. A vehicle seat air-conditioning device, comprising:
a branch duct that is branched laterally from a ventilation duct on a condition of being mounted in a vehicle, the ventilation duct that delivers air, which is blown from an air conditioning unit that air-conditions an inside of a vehicle compartment, to a periphery of a rear seat; and
a blower that draws air from the branch duct and blows the air into a ventilation path formed in a blowing target seat, wherein
the blower is arranged on a lateral side of the ventilation duct on the condition of being mounted in the vehicle.

2. The vehicle seat air-conditioning device according to claim 1, wherein
the blower is fixed to a floor of the vehicle compartment on the condition of being mounted in the vehicle, and
an air outlet port of the blower is connected to the ventilation path through a connection duct on the condition of being mounted in the vehicle, and the connection duct has flexibility.

3. The vehicle seat air-conditioning device according to claim 2, wherein
the blower and the ventilation duct are arranged between the floor and a carpet that is placed on the floor under the blowing target seat on the condition of being mounted in the vehicle.

4. The vehicle seat air-conditioning device according to claim 2, further comprising
a bracket that fixes the blower to the floor, wherein
the blower is fixed to the floor by being fixed to the bracket on an upper side of the blower on the condition of being mounted in the vehicle.

5. The vehicle seat air-conditioning device according to claim 4, wherein
the bracket has a blower supporting portion that is located on the upper side of the blower on the condition of being mounted in the vehicle, and the blower is fixed to the blower supporting portion, and
the blower supporting portion has a height that is equal to a height of the ventilation duct on the condition of being mounted in the vehicle.

6. The vehicle seat air-conditioning device according to claim 2, wherein
the blowing target seat has four seat connectors on a lower side of the blowing target seat, and the four seat connectors connect the blowing target seat to the floor, and
the blower and the branch duct are arranged in a front portion of an area that is defined as an inside of a quadrangle of which four corners respectively coincide with the four seat connectors.

7. The vehicle seat air-conditioning device according to claim 1, further comprising
an air inlet part that forms an air inlet space opening to an air suction port of the blower and is arranged on a lower side of the blower in an upper-lower direction of the vehicle, wherein
the branch duct has one end that communicates with an inside of the ventilation duct and an other end that communicates with the air inlet space, and
the air inlet part is formed such that the air suction port of the blower is located below an uppermost portion of the blower in the upper-lower direction in cross section at a portion in which the air inlet part branches to the branch duct.

8. The vehicle seat air-conditioning device according to claim 1, further comprising:
an inside-air introducing portion that is open to the inside of the vehicle compartment and into which air inside of the vehicle compartment flows; and
a switching mechanism that alternatively flows air delivered from the ventilation duct or air delivered from the inside-air introducing portion to the blower.

9. The vehicle seat air-conditioning device according to claim 8, wherein
the inside-air introducing portion is configured by a duct that protrudes laterally from the branch duct on the condition of being mounted in the vehicle.

10. The vehicle seat air-conditioning device according to claim 1, wherein
the ventilation duct has:
an air outlet port that is open to blow air to the periphery of the rear seat; and
a wind direction guide that is formed in the ventilation duct and sets an airflow direction in the air outlet port, and
the branch duct is connected to the ventilation duct to be located outside of the wind direction guide in the airflow direction in the ventilation duct.

11. The vehicle seat air-conditioning device according to claim 10, wherein
the branch duct is connected to the ventilation duct on an upstream side of an upstream end of the wind direction guide in the airflow direction.

12. The vehicle seat air-conditioning device according to claim 1, wherein
the ventilation duct has:
an air outlet port that is open to blow air to the periphery of the rear seat; and
a branch-duct connector portion to which the branch duct is connected, wherein
the branch-duct connector portion has a sectional area that is smaller than or equal to 80% of an opening area of the air outlet port.

13. The vehicle seat air-conditioning device according to claim 1, wherein
the ventilation duct has a branch-duct connector portion to which the branch duct is connected, and
the branch duct has a sectional area that is larger than or equal to 20% of a sectional area of the branch-duct connector portion.
